(19) United States
(12) Patent Application Publication
(10) Pub. No.: US 2011/0087474 A1
(43) Pub. Date: Apr. 14, 2011

(54) SIMULATOR SYSTEM AND METHOD

(75) Inventors: Ole Paulsen, Stavanger (NO); Bjarne Larsen, Kristiansand (NO); Ove Sandve, Stavanger (NO); Jens Hodne, Kristiansand (NO)

(73) Assignee: Aker MH AS, Kristiansand (NO)

(21) Appl. No.: 12/922,062

(22) PCT Filed: Mar. 10, 2009
(86) PCT No.: PCT/NO09/00085

§ 371 Date: Dec. 8, 2010

(30) Foreign Application Priority Data
Mar. 11, 2008 (NO) 20081293

(51) Int. Cl. G06G 7/48

(52) U.S. Cl. 703/7

(57) ABSTRACT

A simulating system comprises an input device, intended to be operated by an operator, a simulator arrangement, and a display. The simulator arrangement is configured to read a signal representing an operation of the input device, and to simulate equipment using said input signal and pre-stored equipment characteristics. The equipment may be drilling equipment for use in offshore oil/gas exploration. The system results in a visual representation of the equipment, manipulated by the input device. The simulator arrangement comprises an equipment controller, connected to an environment simulator that provides the visual representation of the equipment. The environment simulator is connected to an object database comprising equipment objects.

### FIELD OF THE INVENTION

The present invention relates to simulation of equipment, in particular in the field of drilling operations in oil/gas exploration.

### BACKGROUND ART

There is a growing need for qualified drilling personnel on drill rigs, particularly in offshore oil and gas exploration and production. New and improved simulating and visualizing tools for use in educating/training such personnel are necessary in order to ensure increased security, improved decision-making activities and reduced costs.

There is also a need for testing and verifying control systems used in drilling operations on a drill rig, in particular control software and processes associated with equipment for use in drilling operations.

Certain aspects of the background art are further explained with reference to FIGS. 1 and 2 and their corresponding description below.

### SUMMARY OF THE INVENTION

An overall object of the present invention is to provide a method and a system for simulating an equipment, which overcome or reduce disadvantages of the background art.

This is achieved by means of a method and a system as set forth in the appended independent claims.

Further objects and advantages are achieved by the elements specified in the dependent claims.

Additional features and principles of the present invention will be recognized from the detailed description below.

It is to be understood that both the foregoing general description and the following detailed description are exemplary and explanatory only and are not restrictive of the invention, as claimed.

### BRIEF DESCRIPTION OF THE DRAWINGS

The accompanying drawings illustrate the principles of the invention. In the drawings,

FIG. 1 is an exemplary block diagram illustrating the principles of a control system according to prior art,

FIG. 2 is an exemplary block diagram illustrating the principles of a simulator system according to prior art,

FIG. 3 is an exemplary block diagram illustrating the principles of a simulator system according to an embodiment of the invention,

FIG. 4 is an exemplary block diagram illustrating the principles of a simulator system according to a second embodiment of the invention.

FIG. 5 is an exemplary block diagram illustrating the principles of a simulator system according to a third embodiment of the invention.

FIG. 6 is an exemplary flow chart illustrating the principles of a method according to an embodiment of the invention.

FIG. 7 is an exemplary block diagram illustrating the principles of a movement axis simulator.

### DETAILED DESCRIPTION

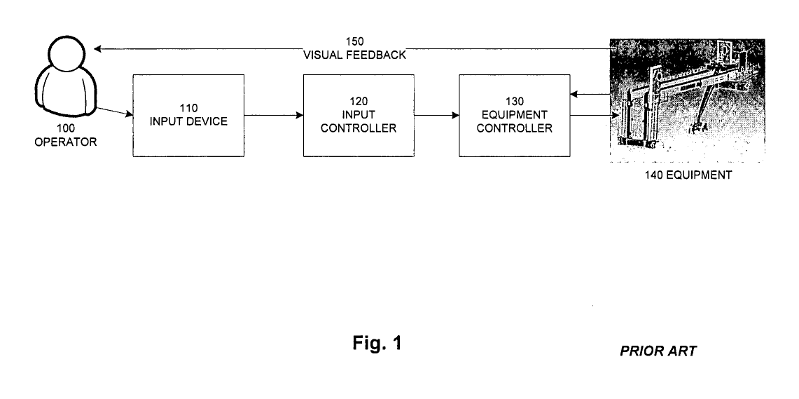

FIG. 1 is an exemplary block diagram illustrating the principles of a control system according to prior art.

The system shown in FIG. 1 comprises an equipment 140, which may be exemplified as a drilling equipment for use on a drill rig, e.g. an drill rig for offshore oil/gas production. As an illustrative example, the equipment 140 may be a crane for use in drilling operations, e.g. for manipulating parts of a drill string during drilling operations.

The system shown in FIG. 1 may e.g. be used for training a human drilling operator 100. In this case, the equipment 140 may be localized at a training site, e.g. on land. Alternatively, the system may be situated and operated on the drill rig.

The operator 100 operates at least one input device 110, e.g. a joystick.

The input device 100 is operatively connected to an input controller 120, which converts the input controller signal and transfers it to a signal suitable for reading by the equipment controller 130.

The equipment controller 130 may typically be a computer-implemented controller, i.e. a computer device equipped with suitable input/output devices and a control process implemented by computer program instructions, i.e. controller software, loaded into a memory and executed by a processing device. As indicated with arrows, the equipment controller 130 receives signals provided by the input controller 120 and by the equipment 140. The input signals are processed by the processing device and results in an output signal which is fed to the equipment 140.

As indicated by the arrow 150, the operator 100 may acquire visual feedback from the operation of the equipment 140. For instance, the operator may manipulate the movement of a moving part included in the equipment 140 by means of the input device, and the operator can observe the actual movement of the moving part. In this way the operator's behaviour is included in the dynamics of the resulting control loop. This mode of operation may be useful for the objective of training the operator in the operation of the equipment 140.

However, the system of FIG. 1 requires the use of an actual piece of equipment 140, which is often disadvantageous. If the equipment is physically located on the drill rig, it will usually be necessary to localize the entire training system and the operator on the drill rig as well. This may be cumbersome, hazardous and expensive.

In particular, if the equipment 140 is used in oil/gas exploration, there is usually an extensive cost associated with shutting down exploration activities in order to make the equipment 140 available for testing/training purposes.

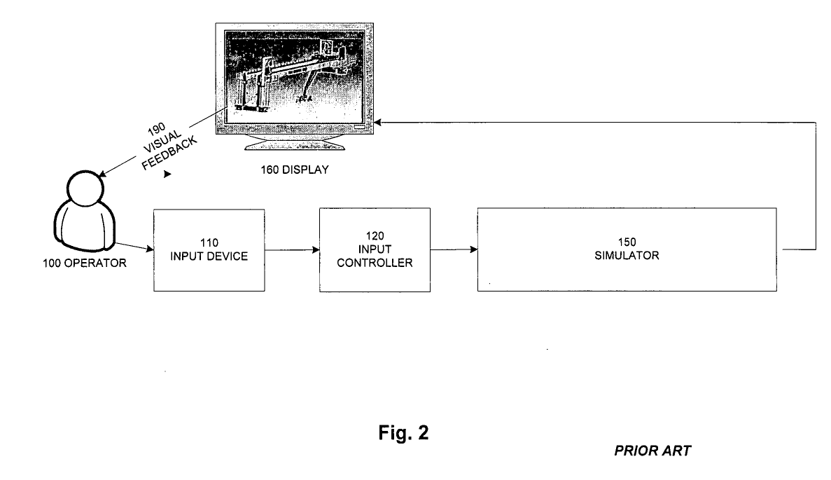

In order to avoid or reduce some of the above disadvantages, simulator systems of the kind illustrated in FIG. 2 have been suggested.

FIG. 2 is an exemplary block diagram illustrating the principles of a simulator system according to prior art.

In FIG. 2, the equipment controller 130 and the equipment 140 shown in FIG. 1 are replaced by a simulator 150. The simulator 150 is customized to simulate the resulting behaviour of the real equipment 140 and the equipment controller 130, based on the signals provided by the input controller 120. The simulator 150 provides, e.g., a 3D animated image, representing the equipment 140, which may be displayed on the display screen 160. The arrow 190 indicates the visual feedback provided by the image on the display 160 when observed by the operator 100.

The arrangement illustrated in FIG. 2 is useful for training purposes, since the actual equipment is replaced with simulated equipment. However, it still has the disadvantage that the equipment controller 130, which is used in the actual process on the rig, is not included as a separate element in the resulting feedback loop. Consequently, the characteristics and dynamics of the equipment controller are not properly utilized in the training of the operator 100, which leads to less a realistic simulating environment. Moreover, the system in FIG. 2 does not enable the testing and verification of the equipment controller 130, since its characteristics and dynamics is replaced by rough approximations included in the simulator 150.

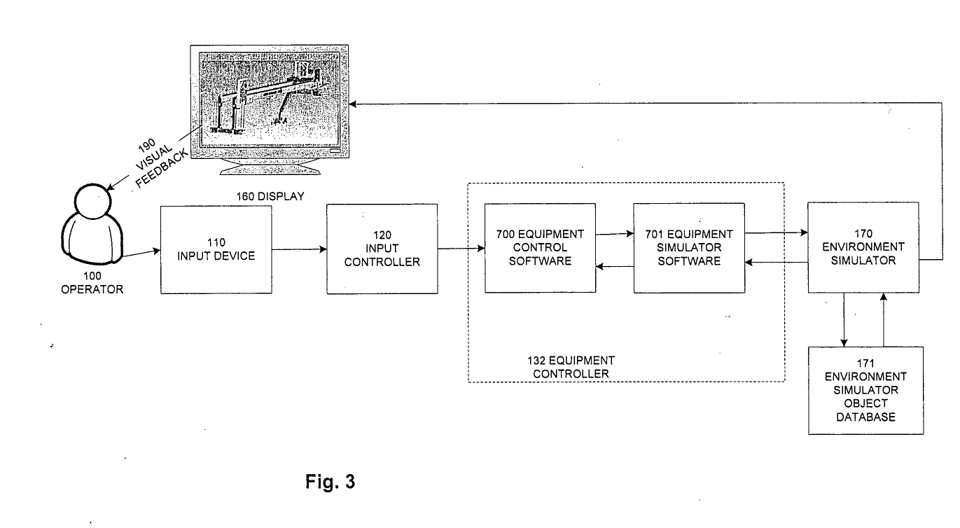

Some of these disadvantages and/or shortcomings may be remedied by the simulator system according to an embodiment of the invention, as illustrated as an exemplary block diagram in FIG. 3.

The system shown in FIG. 3 may e.g. be used for educating/training the human drilling operator 100.

The system shown in FIG. 3 is intended for simulating an equipment, which may be exemplified as a drilling equipment for use on a drill rig, e.g. an drill rig for offshore oil/gas production. As an illustrative example, the equipment may be a crane for use in drilling operations, e.g. for manipulating parts of a drill string during drilling operations.

The operator 100 operates at least one input device 110, e.g. a joystick. Other possible input devices or elements of the input device include buttons, switches, roller balls, steering wheels, hand wheels, touch screen elements, and any other input devices suitable for a human-machine interface, e.g. in a control room for drilling operations on a drill rig. Typically the input devices include a plurality of operating elements.

The operator 100 has been illustrated for explanatory purposes, since he or she will usually be present during the practical use of the system. A human operator is however not a necessary element for the purpose of specifying the present simulator system or method.

The input device 100 is operatively connected to an input controller 120, which converts the input controller signal and transfers it to an input signal suitable for reading by the equipment controller 130.

The input controller 120 may be a multi-equipment operator station controller configured to distribute operator input from the input device 110 to a corresponding equipment controller 132. The output of the input controller is in general a digital signal that may be represented by, e.g., bits, bytes, integer or real variables.

The equipment controller 132 is typically a digital controller, and more specifically a computer-implemented controller, i.e. a computer with suitable input/output devices and a control process implemented by computer program instructions, i.e. controller software, loaded into a memory and executed by a microprocessor. As indicated with arrows arriving at the equipment controller 132, the equipment controller 132 receives signals provided by the input controller 120 and by the environment simulator 170. The input signals are processed by the processing device and results in an output signal which is fed to the equipment simulator 170.

The software included in the equipment controller 132 may, as illustrated, separated into two portions: an equipment control software 700 and an equipment simulator software 701.

The equipment control software used in the equipment controller 132 is advantageously identical to controller software used in the real implementation on the rig, i.e. the equipment controller 130 illustrated in FIG. 1. As a consequence, the equipment control software 700 in the equipment controller 132 has the same characteristics, dynamics and behaviour as the corresponding equipment controller 130 used on the rig. In practice this is achieved by providing the equipment control software 700 in the equipment controller 132 used in the simulator system as a copy of the software used in the equipment controller 130 used in the real-life system.

The equipment control software may, e.g., implement a regular control law suitable for controlling the equipment 140, including, but not restricted to, linear control loops including P, PI, PD, and PID control loops, non-linear control loops, adaptive control loops, multivariable control loops, time-discrete control such as PLC functionality, etc.

In an explanatory example, if the equipment simulator software 701 simulates a crane (i.e. if the actual equipment 140 is a crane), the equipment controller may receive as an input from the input controller 120 a signal representing the requested velocity from the input device 110, which may be a joystick operated by the operator 100. The equipment simulator software may include processes for simulating dynamic properties of the equipment 140 (the crane), including properties of sensor devices included in the equipment 140. Such processes may provide simulated position measurements defining the static and dynamic placement of the crane, hence the operation of the crane. The resulting “simulated sensor devices” may provide output signals from the equipment simulator software 701, which are received as input signals to the equipment control software 700. Based on the input signals from the input controller 120 and the simulated sensor devices in the equipment simulator software 701, and a control law implemented as computer program instructions, or software, in the equipment control software 700, an output signal is calculated by the equipment control software 700 and fed to the equipment simulator software 701. The equipment simulator software 701 may include the process of simulating a cylinder influenced by the signal provided by the equipment control software 700 in order to simulate the operation of a crane.

The environment simulator 170 is a computer-implemented simulator which provides a graphical representation of the real-life, simulated equipment. The representation may be presented to the operator by means of the display screen 160. The environment simulator 170 also provides simulated input from the environment communicated to the Equipment control software 700 through the Equipment simulator software 701. Simulated input from the environment may include simulated sensor devices, such as simulated proximity switches indicating object attached to crane grip and simulated weight-cell indicating mass off attached object. The object properties such as shape (length, diameter, etc), weight, material quality etc are communicated to Environment simulator 170 from Environment simulator object database 171 based on object identification communicated from Environment simulator 170.

As indicated by the arrow 190, the operator 100 may acquire visual feedback from the 3D model of the equipment 140, shown on the display screen 160. For instance, the operator may manipulate the movement of a simulated moving part included in the simulated equipment 140 by means of the input device 110, and the operator can observe the actual movement of the simulated moving part. In this way the operator's behaviour is included in the dynamics of the resulting control loop. This mode of operation may be useful for the objective of educating or training the operator.

In the system in FIG. 3, the equipment controller 132, the environment simulator 170 and the environment simulator object database 171 may be considered as an entity which is denoted in the present specification as a “simulator arrangement”. The simulator arrangement is configured to read the signal from the input controller 120, which represents an operation of the at least one input device 110. The simulating arrangement is further configured to simulate the real-life (physical) equipment 140 using the signal from the input controller and pre-stored equipment characteristics. The simulation results in a visual representation of the equipment 140, manipulated by the input device operated by the operator. The visual representation is presented on the display 160.

As opposed to certain solutions of the background art, the simulating arrangement illustrated in FIG. 3 comprises an equipment controller 132, which is operatively connected to the environment simulator (170), which provides the visual representation of the equipment. The environment simulator is operatively connected to the object database which comprises equipment objects.

Advantageously, the equipment controller is functionally identical to an equipment controller that is suitable for controlling the actual equipment 140.

At least one of, the equipment objects included in the object database include a three-dimensional visual representation of the equipment 140. Typically, the database comprises a plurality of various objects, each representing a piece of equipment.

The equipment objects, or at least one of them, may include a characteristic of a dynamic property of the actual equipment. Such a dynamic property may include a representation of a sensor element included in the equipment.

The relation between the three-dimensional visual representation of an equipment and the dynamic properties of the equipment may, e.g., be established by:
importing CAD objects (corresponding to three-dimensional visual representations) to the environment simulator 170,
importing a representation of the site or area in which the equipment is intended to operate, e.g. provided by a laser scan process or by CAD models of the site or area,
configuration of equipment movements,
mapping of control system variables into a data distribution facility,
configuring equipment movements and their relation to control system variables,
mapping of sensor feedback and equipment feedback from the equipment simulator software back to equipment control software,
testing, including operating equipment from control systems and comparing such operation with results of simulating.

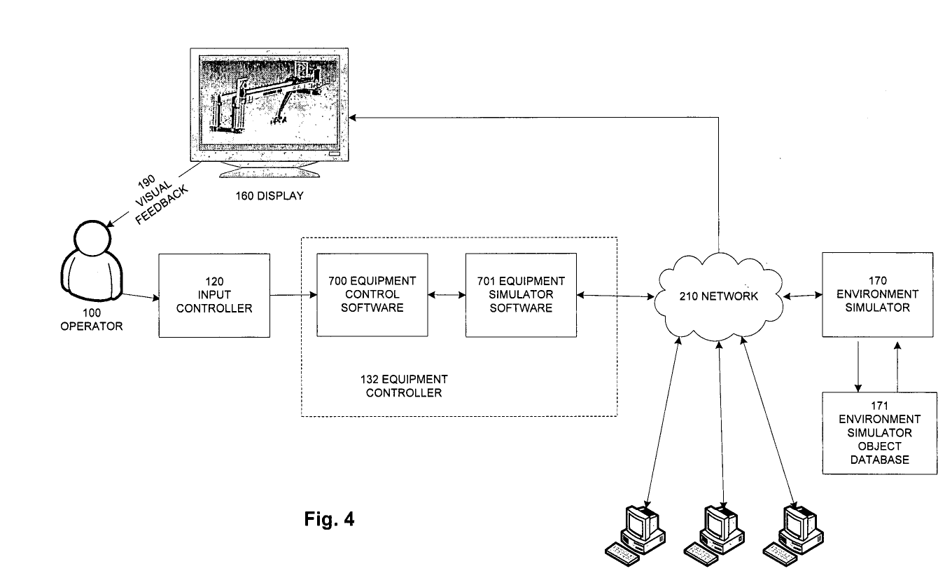

FIG. 4 is an exemplary block diagram illustrating the principles of a second embodiment of a simulator system according to the invention.

The system of FIG. 4 is identical to the system illustrated in FIG. 3 in most respects, and the corresponding description relating to FIG. 3 above is referred to in order to disclose the embodiment of FIG. 4.

However, in FIG. 4, the simulator arrangement, i.e. the combination of the equipment controller 132, the environment simulator 170 and the environment simulator object database, operates in a client-server environment that includes the network 210. The network 210 may, e.g., be a TCP/IP enabled communications network, or any other type of communications network. The network 210 may comprise a local area network, a wide area network, and/or even a global communications network such as the Internet. The environment simulator may be configured as a server in order to provide an environment simulator service to a simulator client or a plurality of simulator clients, communicatively operating via the network 210.

Moreover, for simplicity, the input device 110 and the input controller 120 have been illustrated in FIG. 4 as a single system element.

The client/server configuration illustrated in FIG. 4 makes it possible to arrange a simulator/training site virtually at any place, different from the site of the environment simulator server 220. Thus, training of personnel may be more conveniently performed without the need for co-localization of the operator and the server. It also enables a single environment simulator server to serve a plurality of simulator clients.

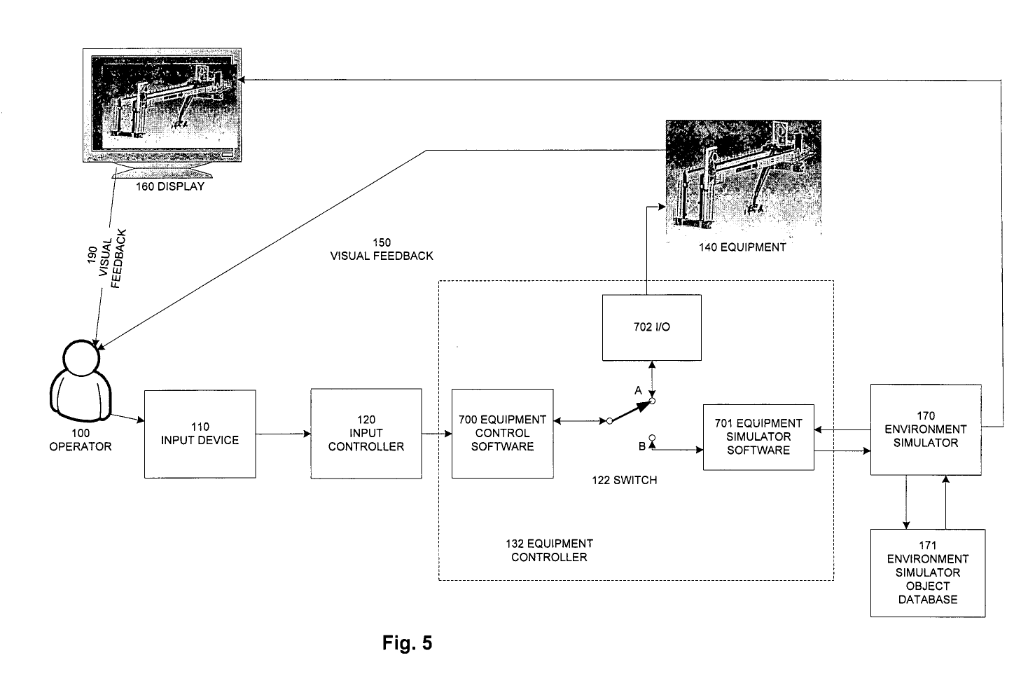

FIG. 5 is an exemplary block diagram illustrating the principles of a third embodiment of a simulator system according to the invention.

The system of FIG. 5 is identical to the system illustrated in FIG. 3 in most respects, and the corresponding description relating to FIG. 3 above is referred to in order to disclose the embodiment of FIG. 5.

However, the direct connection between the equipment control software element 700 and the equipment simulator software element 701 has been replaced by a virtual or logical switch 122. The switch symbol is arranged for explanatory purposes, and is intended to illustrate that the signal provided by the equipment control software element 700, i.e. a control signal suitable as an input signal (after processing in an I/O device) for the actual equipment 140 may either (position B) be fed to the equipment simulator software 701, resulting in the system previously described with reference to FIG. 3, or (position A) it may be fed via appropriate I/O adaptation circuits 702 to the actual (real-life) equipment 140 as previously described with reference to FIG. 1.

It should be understood that the signal provided by the equipment control software element 700 may alternatively be fed both to the equipment simulator software 701, thus controlling the simulated equipment, and via the I/O element 702 to the equipment 140, thus also controlling the equipment 140. Such operation may be useful for verification of the equipment model implemented by the overall simulating system.

The switch 122 may in practice be controlled by a parameter setting, e.g. one bit, that decides whether the output of the equipment control software 700 is directed to the I/O element 702, which may include I/O handling software for real life operation, or to the equipment simulator software 701, resulting in simulated operation of equipment, or both.

It should also be appreciated that the client/server features of the second embodiment (FIG. 4) may readily be combined with the inclusion of the real-life equipment 140 as illustrated in the third embodiment (FIG. 5).

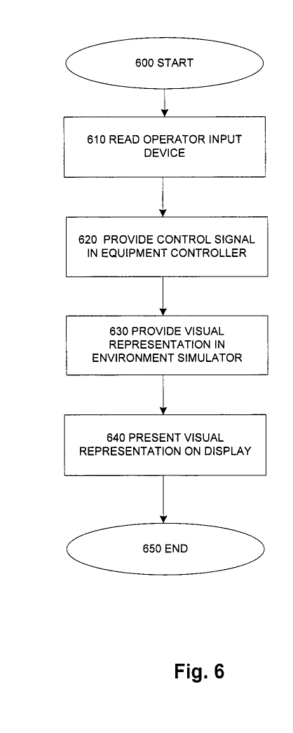

FIG. 6 is an exemplary flow chart illustrating the principles of a method or process for simulating an equipment according to an embodiment of the invention.

The process starts at the initiating step 600.

Then, in the reading step 610, a signal representing an operation of an input device, such as an input device previously described in the present disclosure, is read into the process. The signal or signal value may e.g. be stored in a memory.

Further in the process, the equipment is simulated using the input signal and pre-stored equipment characteristics. The simulating results in a visual representation of the equipment, which is then presented on a display.

More specifically, in the next step, the control signal providing step 620, a control signal that would be suitable for controlling the actual equipment (140), is provided in an equipment controller. As previously explained with reference to embodiments of a system that implements the method, as illustrated in FIGS. 3, 4, and 5, the procedure of providing of the control signal may be identical to a procedure suitable for controlling the actual equipment.

Next, in step 640, the visual representation of the equipment (140) is provided in an environment simulator. The environment simulator is operatively connected to an object database that comprises equipment objects. At least one of the equipment objects includes a three-dimensional visual representation of the actual equipment. Moreover, at least one of the equipment objects include characteristic of a dynamic property of the equipment, and such a characteristic may, e.g., include a representation of a sensor element included in the equipment.

In an embodiment of the method, the simulating step may be performed in a client-server environment. Such a method corresponds to the system embodiment of FIG. 4.

In another embodiment of the method, the control signal suitable for controlling the equipment may be selectively connected to the environment simulator, or the equipment, or both. Such a method corresponds to the system embodiment of FIG. 5.

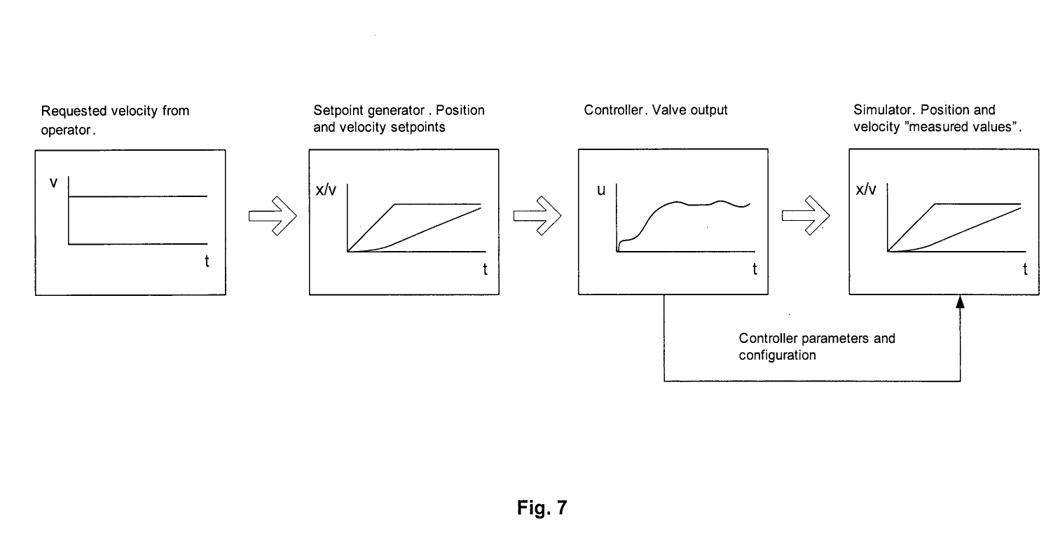

FIG. 7 is an exemplary block diagram illustrating the principles of a movement axis simulator, which may form part of the equipment simulator software 701 illustrated in FIGS. 3, 4, and 5.

The purpose of the movement simulator is to ensure that the movement axes behave exactly the same in the simulator as on the physical equipment. In general this is solved by a discrete mathematic model of the axis parameterised with data based on measurements or experience from similar axis. This general approach results in an axis simulator that has to be put together with a movement controller parameterised to fit that exact mode. Seldom will the controller parameters for one axis be the same in the simulator and on the equipment. Measurement or experience data from similar axis is never exact.

The movement simulator diverges from certain other simulators by the way it is parameterised. Each movement axis is parameterised solely by the movement controller parameters. In general the simulator expresses the inverse characteristic of the equipment controller 132. This ensures that the axis behaves as expected independent of the tuned controller parameters.

### Benefits:

Allows us to test the software in the simulator with initial controller parameters with expected behaviour of the movement axis.

Allows us to retest the software in the simulator with controller parameters tuned in on the physical machine with no changes to the software or configuration/parameters, but still archive expected behaviour of each axis.

One can argue that the disadvantage of doing it like this is that the simulator will not reveal any discrepancies in the controller parameters. This is partly correct. The tuning parameters must be of correct type with correct sign and within reasonable limits, but except for that the axis simulator behaves as expected regardless of controller parameters. However, experience has shown that it is not necessarily worth the effort to establish a model that is exact enough to make it useful to tune controller parameters.

Although simulation of drilling equipment for use in drilling operations on a drill rig has been used as a specific example in the above detailed description, the skilled person will readily recognize that the present invention may likewise be applicable in other fields. Such alternative fields include subsea installations/equipment, processing facilities, robotics, industrial robotized assembly/manufacturing lines, operating equipment without a control system, other fields where control systems and industrial sensors/detectors are used, and combined operations of real and virtual equipment

The above detailed description has explained the invention by way of example. A person skilled in the art will realize that numerous variations and alternatives to the detailed embodiment exist within the scope of the appended claims.

1.-14. (canceled)

15. A system for simulating an equipment, comprising:
an input device intended to be operated by an operator;
a display; and
a simulator arrangement, configured to:
read a signal representing an operation of the input device;
simulate said equipment using said input signal and pre-stored equipment characteristics, resulting in a visual representation of the equipment; and
present said visual representation on said display,
wherein said simulator arrangement comprises:
an equipment controller, operatively connected to an environment simulator, providing said visual representation of the equipment, said environment simulator being operatively connected to an object database comprising equipment objects,
wherein said equipment controller is functionally identical to a real-life equipment controller suitable for controlling the equipment, the equipment controller being separate from the real-life equipment controller, the equipment controller comprising equipment control software which is a copy of software used in the real-life equipment controller.

16. The system according to claim 15, wherein at least one of said equipment objects includes a three-dimensional visual representation of the equipment.

17. The system according to claim 15, wherein at least one of said equipment objects includes characteristics of a dynamic property of said equipment.

18. The system according to claim 17, wherein said dynamic property includes representation of a sensor element included in the equipment.

19. The system according to claim 15, wherein said simulator arrangement is operating in a client-server environment.

20. The system according to claim 15, wherein said equipment controller is adapted for selectively directing a control signal in the equipment controller to the environment simulator, or the equipment, or both of the environment simulator and the equipment.

21. A method for simulating an equipment, comprising the steps of:
reading a signal representing an operation of the input device;
simulating said equipment using said input signal and pre-stored equipment characteristics, resulting in a visual representation of the equipment; and
presenting said visual representation on a display,
wherein said simulating step further comprises:
providing a control signal suitable for controlling the equipment in an equipment controller; and
providing said visual representation of the equipment in an environment simulator, said environment simulator being operatively connected to an object database comprising equipment objects,
wherein said step of providing, in the equipment controller, of a control signal suitable for controlling the equipment is functionally identical to an equipment controlling procedure suitable for controlling the equipment, the equipment controller being separate from the real-life equipment controller, the equipment controller comprising equipment control software which is a copy of software used in the real-life equipment controller.

22. The method according to claim 21, wherein at least one of said equipment objects includes a three-dimensional visual representation of the equipment.

23. The method according to claim 21, wherein at least one of said equipment objects includes characteristics of a dynamic property of said equipment.

24. The method according to claim 23, wherein said dynamic property includes a representation of a sensor element included in the equipment.

25. The method according to claim 21, wherein said simulating step is performed in a client-server environment.

26. The method according to claim 21, wherein said control signal suitable for controlling the equipment is selectively connected to the environment simulator, or the equipment, or both of the environment simulator and the equipment.

27. The system according to claim 16, wherein at least one of said equipment objects includes characteristics of a dynamic property of said equipment.

28. The system according to claim 16, wherein said simulator arrangement is operating in a client-server environment.

29. The system according to claim 17, wherein said simulator arrangement is operating in a client-server environment.

30. The system according to claim 16, wherein said equipment controller is adapted for selectively directing a control signal in the equipment controller to the environment simulator, or the equipment, or both of the environment simulator and the equipment.

31. The system according to claim 17, wherein said equipment controller is adapted for selectively directing a control signal in the equipment controller to the environment simulator, or the equipment, or both of the environment simulator and the equipment.

32. The system according to claim 18, wherein said equipment controller is adapted for selectively directing a control signal in the equipment controller to the environment simulator, or the equipment, or both of the environment simulator and the equipment.

33. The system according to claim 19, wherein said equipment controller is adapted for selectively directing a control signal in the equipment controller to the environment simulator, or the equipment, or both of the environment simulator and the equipment.

34. The method according to claim 22, wherein at least one of said equipment objects includes characteristics of a dynamic property of said equipment.
